(19) United States
(12) Patent Application Publication
(10) Pub. No.: US 2010/0170797 A1
(43) Pub. Date: Jul. 8, 2010

(54) DEVICE AND METHOD FOR SINGLE CELL AND BEAD CAPTURE AND MANIPULATION BY DIELECTROPHORESIS

(75) Inventors: Jessica L. Arlett, South Pasadena, CA (US); Ji Hun Kim, Pasadena, CA (US); Michael L. Roukes, Pasadena, CA (US)

Correspondence Address: KAUTH , POMEROY , PECK & BAILEY ,LLP, 2875 MICHELLE DRIVE, SUITE 110, IRVINE, CA, 92606, US

(73) Assignee: California Institute of Technology, Pasadena, CA (US)

(21) Appl. No.: 12/684,357

(22) Filed: Jan. 8, 2010

Related U.S. Application Data
(60) Provisional application No. 61/204,557, filed on Jan. 8, 2009.

(51) Int. Cl. B01D 57/02

(52) U.S. Cl. 204/547; 204/643

(57) ABSTRACT

A rapid and robust device and method for the capture and manipulation of single cells and beads in a microfluidic environment using positive dielectrophoresis (pDEP) is provided. The capture device uses a highly localized and non-uniform pDEP electric field gradient to allow for the simultaneous capture and manipulation of single cells and beads in standard cell growth media.

### CROSS REFERENCE TO RELATED APPLICATIONS

The current application claims priority to U.S. Provisional Application No. 61/204,557, the disclosure of which is incorporated herein by reference.

### STATEMENT OF FEDERAL SUPPORT

The U.S. Government has certain rights in this invention pursuant to Grant No. GM072898 awarded by the National. Institutes of Health and Grant No. HR0011-06-1-0043 awarded by DARPA.

### FIELD OF THE INVENTION

The current invention is directed to a device and method for the manipulation of single cells and beads in microfluidic environments; and more particularly to a device and method for manipulating single cells and beads using positive dielectrophoresis.

### BACKGROUND OF THE INVENTION

In recent years there has been a great interest in developing methods of performing single cell analysis. True single cell analysis has the potential to enhance our understanding of diverse processes in biological sciences. For example, cells, believed to be genetically identical, have been shown to respond in different ways to the same stimulus (known as cellular heterogeneity). (See, e.g., J. E. Ferrell and E. M. Machleder, Science, 1998, 280, 895-896; M. N. Teruel and T. Meyer, Science, 2002, 295, 1910-1912; and H. Rubin, PNAS, 1984, 81, 5121-5125, the disclosures of which are each incorporated herein by reference.) Although some bulk cellular heterogeneity experiments are possible (see references cited above), any efforts to lyse the cell (e.g. to perform quantitative mRNA analysis) or to perform quantitative analysis on secreted proteins would inherently be averaged by the population, limiting the quantitative data that can be obtained. Accordingly, while a number of novel assays have been developed to study this cellular heterogeneity, an automated, easy-to-use parallel assay for a large population of single cells, could provide the foundation for significant advances.

Microfluidic analysis, has the potential ability to individually segregate a population of cells, which offers the possibility for more thorough and quantitative analysis. (See, e.g., J. F. Zhong, et al., Lab on a Chip, 2008, 8, 68-74, the disclosure of which is incorporated herein by reference.) Polydimethylsiloxane (PDMS)-based microfluidics are well suited to such applications, as the gas permeability of the material allows for well-controlled cell growth and the ease of fabricating pumps and valves allows for large arrays of individually addressable chambers. (See, e.g., T. Thorsen and S. J. Maerkl, Science, 2002, 298, 580-584; and R. Gomez-Sjoberg, et al., Anal. Chem., 2007, 79, 8557-8563, the disclosures of each of which are incorporated herein by reference.)

Using such microfluidic devices it is possible to achieve maximum fluorescent detection sensitivity for single cell assays by capturing the target molecules in a small area. This can be achieved through the functionalization of very small regions of the channel, or more simply by functionalizing microbeads off chip and then capturing them in the desired location to be functionalized. Under most conditions, such as where the surface volume ratio is greater than 100 μm²/nL, the smaller the bead, the better the sensitivity. However, in order for a bead-based method to be used in a practical multiplexed assay, the system must be capable of transporting and capturing single cells and beads, and the system must be robust and fast. For example, even in a system capable of achieving a 90% capture rate of individual beads, the probability of successfully capturing 5 single beads is ˜60%. Therefore, a near-perfect capture system is required.

One technique for performing such capture that has shown great promise uses dielectrophoresis (DEP). DEP has been used in a variety of fields, for example, cell sorting and cell/particle capture, for several decades, and it has been explained by the effective moment method. In this method the cell is modeled as small electric dipole in slightly nonuniform electric field and the effective moment is defined like below. DEP can be operated in two modes, a negative mode, in which cells and beads are pushed away from the source of the DEP electric field, and in a positive mode, in which the cell or bead is attracted to the source of the DEP electric field. A parameter known as the Clausius-Mosotti factor [K] is generally used to estimate the magnitude of dielectrophoresis, a positive Clausius-Mosotti factor means that the particle will be attracted (pDEP) while a negative Clausius-Mosotti factor means that it will be repelled (nDEP).

There are significant benefits to using positive dielectrophoresis over negative dielectrophoresis for cell capture. Most notably the device design complexity is simpler and requires less optimization (and subsequent redesign for different cell types). However, it has been widely believed that positive dielectrophoresis capture of single cells was not possible in cell growth media, and that using the accepted values for the permittivity and conductivity of the cell, would always lead to negative dielectrophoresis for all frequencies. (See, e.g., Mettal, N. et al., Lab Chip, 2007, 7, 1146-1153; Mettal, N. et al., Supp. Mat. Lab Chip, 2007, 7, 1146-1153; Gray, D. S. et al., Biosensors and Bioelectronics, 2004, 19, 771-780; and Taff, B. M and Voldman, J., Anal. Chem., 2005, 77, 7976-7983, the disclosures of each of which are incorporated herein by reference.) Accordingly, a need exists for an improved microfluidic device capable of transporting and capturing single beads and cells using a pDEP method.

### SUMMARY OF THE INVENTION

The current invention is directed to a pDEP microfluidic single particle capture device and method.

In one embodiment, the pDEP microfluidic single particle capture device includes at least one pair of shielded electrodes where the exposed regions of the electrodes define a particle capture region. In such an embodiment the particle capture region is dimensioned and disposed such that an electric field is propagated that has a frequency and is nonuniform across and localized on the size-scale of the particle such that an attractive positive electrical polarization is generated between the particle and the particle capture region sufficient to generate a restoring force at the particle capture region capable of fixing a single particle in place but that dissipates at a distance away from the particle capture region such that additional particles are not captured.

In another embodiment, the electrodes are shielded with a material having a low dielectric constant. In one such embodiment the material is parylene.

In still another embodiment, the electrodes have a geometry selected from the group consisting of semicircular and triangular.

In yet another embodiment, the particle is one of either a cell or a bead. In an embodiment where the particle is a cell, the fluid medium is a cell growth medium.

In still yet another embodiment, the frequency of the electric field is at least 500 kHz.

In still yet another embodiment, the frequency of the electric field may be reduced such that a repulsive force is generated at the particle capture region sufficient to dislodge a particle captured thereon. In one such embodiment, the repulsive force is created by the formation of gas bubbles through electrolysis.

In still yet another embodiment, the microfluidic channel has a height of less than 12 μm.

In still yet another embodiment, the microfluidic device is formed of PDMS.

### BRIEF DESCRIPTION OF THE DRAWINGS

Various examples of the present invention will be discussed with reference to the appended drawings. These drawings depict only illustrative examples of the invention and are not to be considered limiting of its scope.

FIG. 1 provides a schematic of a pDEP microfluidic single particle capture device in accordance with one exemplary embodiment of the invention;

FIG. 2 provides schematics of modeling cell geometries as used in the simulations set forth in FIGS. 3 and 4;

FIG. 3 provides a data plot of Re[K] as a function of frequency for a cell in a weakly nonuniform electric field under the following conditions: conductivity of media (13800 uS/cm), conductivity of macrophage cytoplasm (6000 uS/cm), dielectric constant of media (80), dielectric constant of macrophage cytoplasm (126.8), macrophage membrane capacitance (1.53 uF/cm̂2), radius of macrophage (4.63 um);

FIG. 4 provides: (a) a simulation of the electric field generated by unpassivated electrodes with 5 Vpp in 25 um high, 100 um wide channel, and (b) a data plot of the electric polarization of the cell as a function of frequency;

FIG. 5 provides: (a) a simulation of the electric field generated by passivated or shielded electrodes with 5 Vpp in 12 um high, 100 um wide channel where the top of the channel is covered with PDMS, and (b) a data plot of the electric polarization of a cell as a function of frequency under the following conditions: conductivity of media (13800 uS/cm), conductivity of macrophage cytoplasm (6000 uS/cm), dielectric constant of media (80), dielectric constant of macrophage cytoplasm (126.8), macrophage membrane capacitance (1.53 uF/cm²), and radius of macrophage (4.63 um);

FIG. 6 provides: (a) an image showing the capture of small numbers of gold-coated beads with 5 μm diameter using unpassivated electrodes with a 1 μm gap under a 5V p-p bias at 1 MHz, and (b) a plot of a finite element simulation showing the extrusion of the DEP force region beyond the immediate confines of the gap;

FIG. 7 provides: (a) finite element simulations for the electric field for a shielded device in accordance with the current invention, (b) an unshielded device, (c) a schematic diagram of the effect of the DEP restoring force in the third dimension, and (d) finite element simulations for the electric field in the third dimension;

FIG. 8 provides plots of finite element simulations showing the DEP force produced using two shielded electrode geometries in accordance with the current invention (a) triangular geometry and (b) circular geometry;

FIG. 9 provides images of an exemplary single cell/bead capture device in accordance with the current invention and the capture of single cells (a), and single beads (b and c) therewith;

FIG. 10 provides images shown bead release using the pDEP capture device of the current invention wherein in (a) the beads are captured, in (b) a decrease of the applied frequency (down to a few Hz) leads to bubble generation by electrolysis, releasing the beads into the flow, and in (c) the frequency is raised back to 1 MHz, the bubble is eliminated and the capture device can be reused.

FIG. 11 provides cell vitality test results (a) 15 m after cell's captured at room temperature, and (b) 3 h after cell's captured at room temperature; and

FIG. 12 provides a schematic of an exemplary microfluidic device that could be used in conjunction with the pDEP capture device of the instant invention.

### DETAILED DESCRIPTION OF THE INVENTION

The current invention is directed to a rapid and robust device and method for the capture and manipulation of single cells and beads in a microfluidic environment using positive dielectrophoresis (pDEP). In particular, the current invention uses a highly localized and non-uniform pDEP electric field gradient to allow for the simultaneous capture and manipulation of single cells and beads in standard cell growth media.

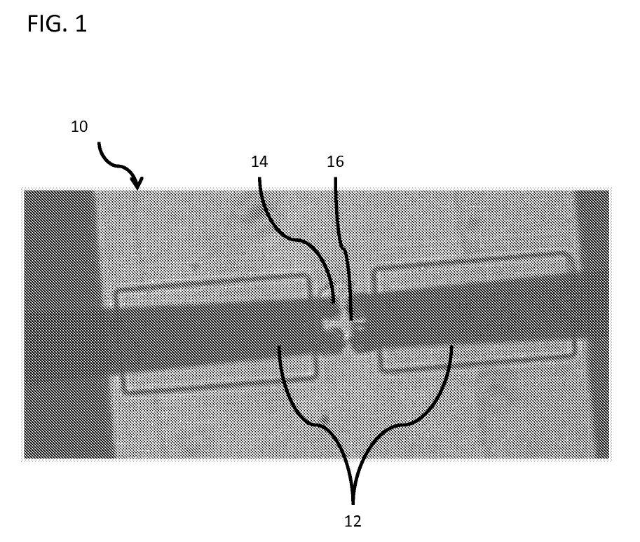

As shown in FIG. 1, in broad terms the pDEP microfluidic single particle capture device (10) of the current invention includes at least one pair of shielded electrodes (12) where the exposed regions of the electrodes define a particle capture region (14), and is dimensioned and disposed such that an electric field is propagated that has a frequency and is nonuniform across and localized on the size-scale of the particle (18) such that an attractive positive electrical polarization is generated between the particle and the particle capture region sufficient to generate a restoring force at the particle capture region capable of fixing a single particle in place but that dissipates at a distance away from the particle capture region such that additional particles are not captured.

Prior to describing the current invention in detail, some background information on the nature of the forces at issue should be provided. It has long been recognized that any polarizable material will exhibit a force in the presence of an electric field gradient. This process is known as dielectrophoresis (DEP) and has been used in cell capture and sorting for years. (See, e.g., S. Prasad, et al., J. of Neuro. Met., 2004, 135, 79-88; B. Sankaran, et al., Electrophoresis, 2008, 29, 5047-5054; X. Hu, et al., PNAS, 2005, 102, 15757-15761; and F. F. Becker, et al., PNAS, 1995, 92, 860-864, the disclosures of each of which are incorporated herein by reference.) The governing equation (ignoring higher order polarization effects) is expressed below:

F_{dep}=2π∈ₘrₚ³Re(f_{CM}(ω))∇Eᵣₘₛ² (1)

where, ∈ₘ is the medium's permittivity, rₚ is the radius of particle, Re(f_{CM}(ω)) is the real part of the Clausius-Mosotti factor, and Eᵣₘₛ is the electrical field.

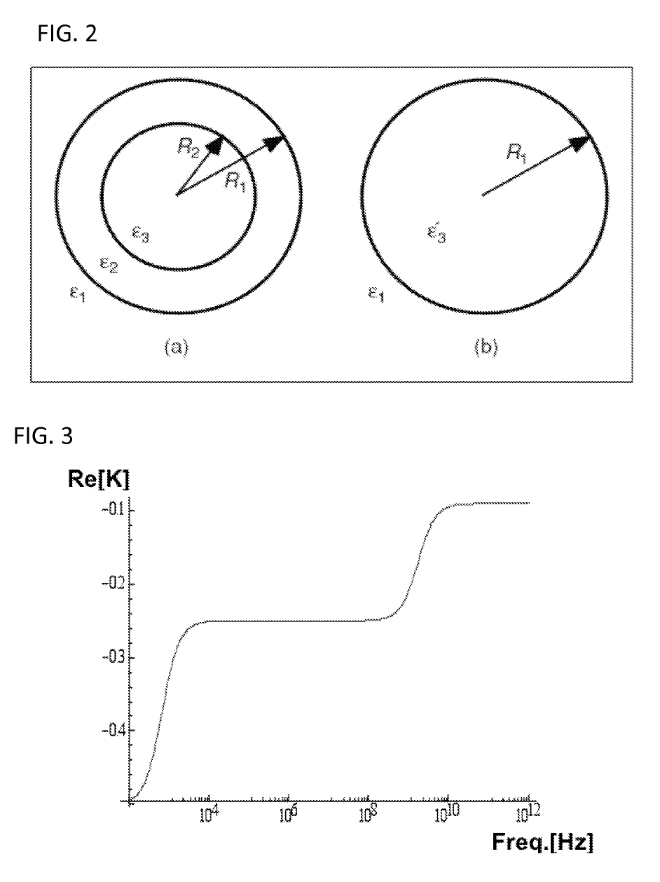

As previously discussed, it has been commonly held that cell capture and manipulation using positive dielectrophoresis is not possible in standard cell growth media. The calculations that led to this belief are based on the assumption that the electric field gradient being applied is relatively uniform across the cell, and that the cell can be represented as a homogenous sphere (from the perspective of the dielectric constant and conductivity), as shown in FIG. 2. In this calculation the cell is modeled as a small electric dipole in a slightly nonuniform electric field and the effective moment is defined in accordance with the following:

p_{eff}=4π∈ₘKr³E (2)

where the Clausius Mosotti factor (K) can be represented by the equation:

$$K = \frac{{ɛ}_{m} - {ɛ}_{p}}{{ɛ}_{m} + 2 {ɛ}_{p}} \qquad [ 3 ]$$

and E is the electrostatic field imposed by the electrodes. The subscript m stands for medium and p for particle, respectively.

In the above equation, the Clausius-Mosotti factor [K] may be used to estimate the magnitude of dielectrophoresis, the sign of Re[K], in turn, gives the sign of force exerted on the cell. A positive sign represents an attracting force towards the electrodes (pDEP), and the negative sign represents a repelling force (nDEP). Since Re[K] is a function of the dielectric constant and conductivity of the cell and media, it is possible to calculate Re[K] as long as each parameter is known.

As previously discussed, conventionally, the cell has been modeled as a spherical particle with one concentric shell (FIG. 2), and under the assumption that the physical scale of the nonuniformity of the imposed electric field is much larger than the particle radius. The aforementioned assumptions, using the accepted values for the permittivity and conductivity of the cell, lead to negative dielectrophoresis for all frequencies, as graphed in FIG. 3. For example, the modeling graphed in FIG. 3 was performed using the following parameters: conductivity of media (13800 uS/cm), conductivity of macrophage cytoplasm (6000 uS/cm), dielectric constant of media (80), dielectric constant of macrophage cytoplasm (126.8), macrophage membrane capacitance (1.53 μF/cm²), radius of macrophage (4.63 μm). These parameters were chosen as appropriate for RAW 264.7 cells, mouse leukaemic monocyte macrophage cell line, in DMEM-based cell growth media. (Docoslis et al., Biotech. & Bioeng., 1997; and Yang et al., Biophysical. Journal, 1999, the disclosures of each of which are incorporated herein by reference.) As shown, even over a broad range of frequencies (12 orders of magnitude) the electric polarization remains negative.

In fact, using this conventional model, normal cell culture media will always give a negative Re[K] sign, thereby giving rise to the standard view that it is physically impossible to capture a cell in normal cell culture media using positive DEP. In the past, these problems have been addressed by either making artificial low conductive media, which threatens the viability of the cells suspended in the media solution, or by using negative DEP (nDEP). However, the above assumptions, particularly the assumption of a uniform electric field gradient, while accurate for conventional. DEP capture conditions, are not representative of the highly localized and non-uniform electric field gradients used in the instant invention. As will be described below, it has been discovered that as nonuniformity increases, and the cell experiences nonuniformities on the size scale of the cell itself, the standard model cannot predict and explain the phenomena experienced by the cell, and a new regime is imposed.

For example, if the cell is placed in the field of a point charge, the effective multipole moment is instead defined by the equation:

$${p}^{( n )} = \frac{4 π {ɛ}_{1} {R}_{1}^{2 n + 1}}{( n - 1 ) !} ⌊ \frac{{( {ɛ}_{2} )}_{n} - {ɛ}_{1}}{{n ( {ɛ}_{2} )}_{n} + ( n - 1 ) {ɛ}_{1}} ⌋ \frac{{\partial }^{t - 1} {E}_{z}}{\partial {z}^{n - 1}} \qquad [ 4 ]$$

where,

$${( {ɛ}_{2} )}_{n}^{′} = {ɛ}_{2} ( \frac{{( {R}_{1} / {R}_{2} )}^{2 n + 1} + ( n + 1 ) K}{{( {R}_{1} / {R}_{2} )}^{2 n + 1} - nK} ) \qquad [ 5 ]$$

and

$$K = \frac{{ɛ}_{3} - {ɛ}_{2}}{n {ɛ}_{2} + ( n + 1 ) {ɛ}_{1}} \qquad [ 6 ]$$

Likewise, it is possible to define an effective multipolar Clausius Mosotti factor:

$${K}^{( n )} = \frac{{( {ɛ}_{2} )}_{n}^{′} - {ɛ}_{1}}{{n ( {ɛ}_{2} )}_{n}^{′} + ( n + 1 ) {ɛ}_{1}} , \qquad [ 7 ]$$

As Re[K] above, Re[K⁽ⁿ⁾] gives the sign of force.

Using this new model, the electric polarization of z(P_z) can be simulated and then integrated over the cell using finite element method (FEMLAB, Comsol) to see whether, under the regime proposed by the current invention, there is a change of sign of P_z of cell at various frequencies. P_z of cell determines the direction of force along z-axis, upward or downward.

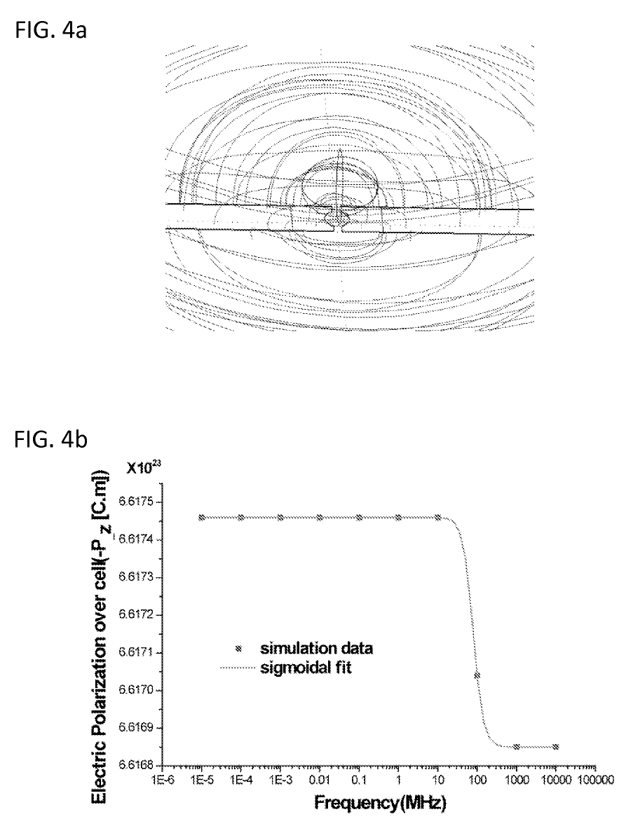

First, in order to see whether this new simulation produces the same result under slightly nonuniform electric fields, the cell was modeled as a sphere and its dielectric constant and conductivity reproduced from the conditions used in the standard model, above. FIG. 4a provides a schematic of an electric field produced from a typical. DEP capture device comprising two unshielded gold electrodes with a 5 um gap distance. The simulation results, provided in the graph of FIG. 4b, again indicates that under these standard slightly nonuniform electric fields, there is no sign change in Re[K], which is consistent with calculation of Re[K] from existing method and model.

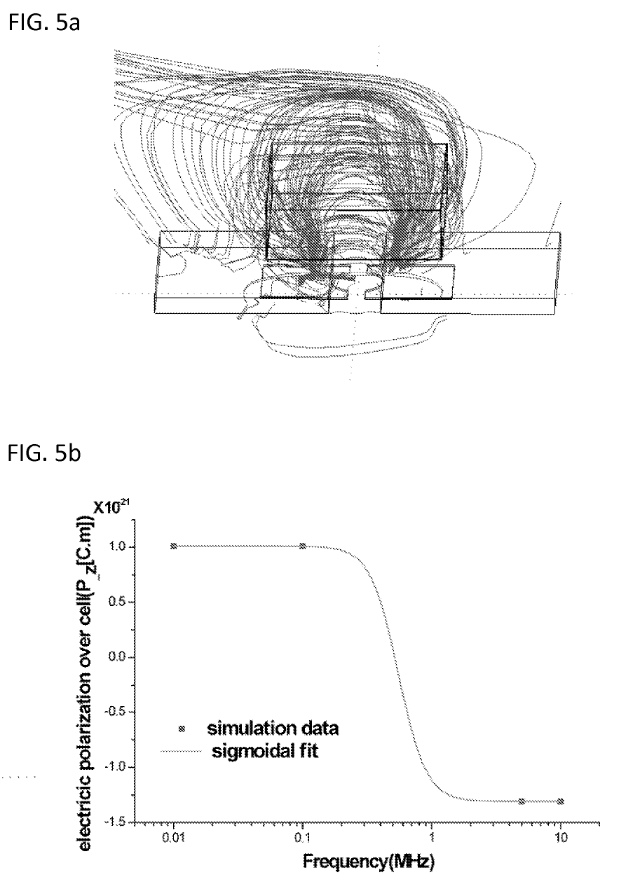

Then the operation of pDEP under the highly localized nonuniform electric fields proposed by the current invention was simulated. As shown in FIG. 5a, in this simulation the cell is modeled as a box (10 um*10 um*3 um) surrounded by a 20 nm thin shell. This allows for an easier simulation, but does not impact the results of the simulations. In this simulation, the electrodes are modeled as being engineered such that they are shielded by a material having a low dielectric constant, such as parylene, so that the electric field propagation has localized nonuniformity on the scale of the cell or bead to be captured/manipulated. (See, e.g., FIG. 5a.) To model the cell capture conditions more accurately the channel thickness is reduced to 12 μm (representing the experimental geometry) with PDMS above this height and parylene is included, covering the electrodes. As shown, both of these corrections serve to localize the electric field. In addition, rather than modeling the cell as homogenous, a thin shell is included to represent the cell membrane. Other conditions used in this simulation are that the conductivity of the media is 13800 uS/cm, the conductivity of the macrophage cytoplasm is 6000 uS/cm, the dielectric constant of the media is 80, the dielectric constant of the macrophage cytoplasm is 126.8, the macrophage membrane capacitance is 1.53 uF/cm̂2, the radius of the macrophage is 4.63 um. Under these condition, it is observed that below ˜500 kHz the cell experiences negative dielectrophoresis, but above this frequency the cell will be attracted by positive dielectrophoresis, as shown in FIG. 5b.

Accordingly, this simulation indicates that, contrary to accepted doctrine, it is possible to perform single cell or bead capture/manipulation using pDEP in standard cell media if the nonuniformity of the electric field is sufficiently localized, i.e., localized at the size scale of the cell or bead. Furthermore, it has been discovered that large, localized electrical field gradients can be achieved by engineering shielded electrodes having an unshielded electrode gap that is on the size-scale of the bead or cell to be captured, such as, for example, <5 μm. As discussed above, the shielding of the electrode may be accomplished using any material that is compatible with the material to be captured and has a dielectric constant low enough to prevent the propagation of the electric field produced by the electrode.

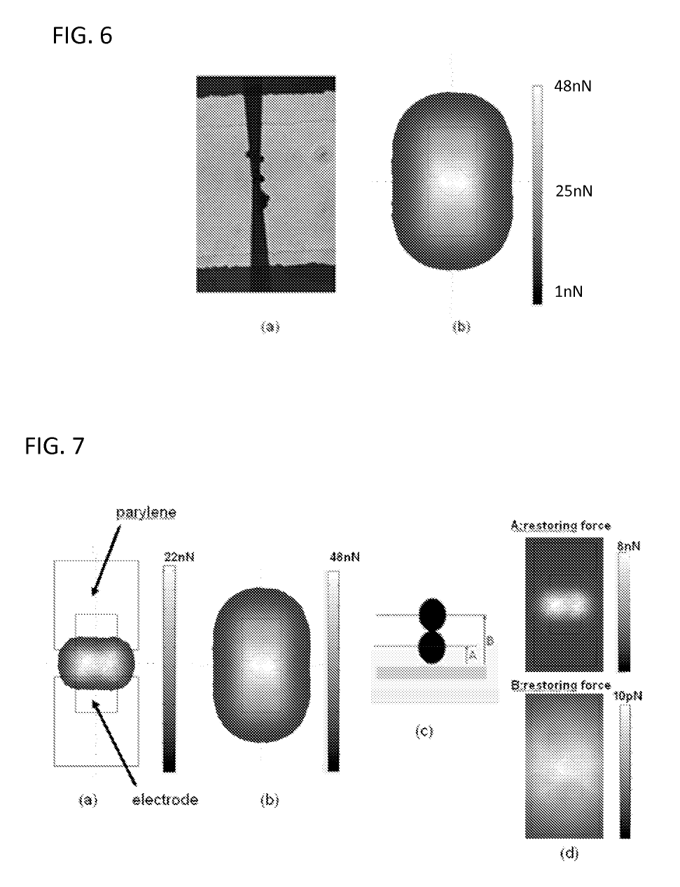

FIGS. 6 and 7 provide a comparison of the capture properties of a conventional unshielded electrode capture element and the shielded localized electric field capture elements of the instant invention. For example, FIG. 6 shows 5 μm gold-coated beads captured with a conventional two-electrode device in which the electrode distance is 1 μm and the applied voltage is 5V p-p at 1 MHz. As shown, beads and cells are captured not only in the gap (where the highest field gradients are generated), but also along the edge of the electrodes. These observations are consistent with finite element simulations (FEMLAB, COMSOL, USA) of the pDEP force in both regions. By contrast, FIG. 7 shows that the DEP force can be controllably localized to the gap region by using the shielded electrodes of the current invention.

Specifically, FIG. 7 provides finite element simulations for a single cell/bead capture device in accordance with the current invention. In order to achieve true single cell/bead capture, the DEP force must be confined in 3-dimensions. It has been discovered that two-dimensional confinement of cells/beads can be achieved by shielding the DEP electrodes to mask all but the localized region of the electrodes that is needed for capture. As shown in FIG. 7, finite element simulations show significant confinement of the electric field for a shielded device in accordance with the current invention (FIG. 7a) as compared to an unshielded device (FIG. 7b). It should be understood that although any material having a low enough dielectric constant to prevent propagation of the electric field may be used to form the shielded electrodes of the instant invention, in a preferred embodiment, the shielding material is parylene, such as, for example, parylene-C. Parylene is preferred because it is biocompatible and chemically inert, reducing the risk of non-specific binding (of both the microbeads/cells and the target protein) to the electrodes. (See, e.g., H. Noh, Ph.D thesis. Georgia Institute of Technology, 2004, the disclosure of which is incorporated herein by reference.)

Although the shielded electrodes described above provide sufficient localization of the DEP force to capture and manipulate the beads in two dimensions, it is also necessary that the DEP force be localized in the vertical direction in order to prevent the capture of a second cell/bead above the first. (See, e.g., FIG. 7c.) This third dimension of confinement may be achieved by a number of means, including modifying the channel height (either by decreasing the actual channel height or by decreasing the height through which cells are permitted to flow via hydrodynamic focusing) to increase the localization of the electric field, by using media that reduces cell adhesion, or by maintaining a shear force, such as by controlling the flow rate of the media, such that the Stokes force exceeds the DEP restoring force at the height at which a second bead might become trapped. Simulations of the restoring force are shown in FIG. 7d. As demonstrated, for a bead of 5 μm diameter in water at a 1 mm/s flow rate at 20° C. the hydrodynamic force is around 47 pN. Such a flow rate would allow for capture at the electrode surface, but not of a second higher bead. Using such simulations, it is possible for one of ordinary skill to design alternative flow channel geometries or flow conditions such that capture of cells/beads out of the plane of the electrode is prevented.

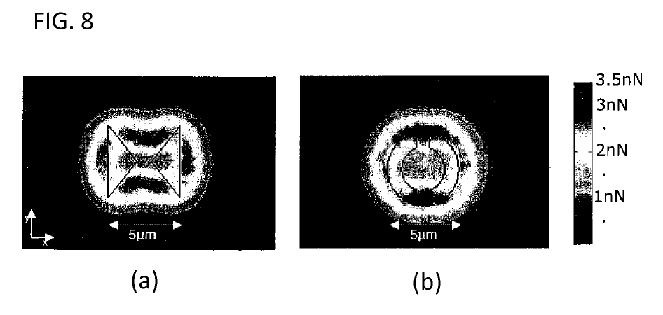

Finally, although the above discussion has described the invention in relation to a curved electrode geometry, such as that shown in FIGS. 4, 5 and 7, it should be understood that the specific design of the opposing electrodes is not critical to the function of the current invention as long as the electrodes are sufficiently shielded such that the electric field propagated therebetween is localized on the size-scale of the cell/bead. As an example, FIG. 8 provides finite element simulations for two different shielded electrode geometries. In FIG. 8a the electrodes are comprised of two triangles having a base of 5 μm, a height of 2 μm and a gap of 1 μm. The second geometry, shown in FIG. 8b, is comprised of two semi-circular regions. As shown, in either case, at a height of about 2.25 μm (one bead radius above the electrodes) the DEP restoring force is almost 2 orders of magnitude greater than then hydrodynamic force, but at a height of 6.75 μm (3/2 of a bead diameter), the maximum DEP restoring force is only 13 pN in any direction of flow. These results combined show that the ability to capture exactly one bead with high probability, with either of these shielded electrode designed is possible.

It should be understood that the above embodiments are not meant to be exclusive, and that other modifications to the basic apparatus and method that do not render the pDEP capture technique inoperative may be used in conjunction with this invention.

### EXEMPLARY EMBODIMENTS

The present invention will now be illustrated by way of the following examples, which are exemplary in nature and are not to be considered to limit the scope of the invention.

### Example 1

### Single Cell/Bead Capture

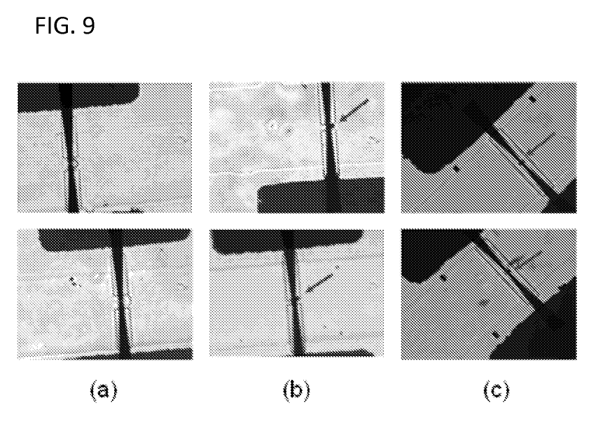

Single cell and single bead capture experiments were performed using a RAW 264.7 mouse leukaemic monocyte macrophage cell line (in cell culture medium) and gold-coated polystyrene beads (microParticles GmbH, Germany, in water). In this exemplary embodiment, these RAW 264.7 cells are shown being captured in cell culture medium (composed of 87% DMEM (Mediatech. Inc. USA) supplemented with 11% Fetal. Bovine Serum, 1% Penicillin/Steptomycin, and 1% non-essential amino acid) in FIG. 9a. In FIGS. 9b and 9c are 5 μm gold-coated polystyrene beads are shown being captured in distilled water.

The cells are approximately 15 μm in diameter and the beads, 5 μm in diameter. The applied voltage is 5V p-p at 1 MHz for both experiments. Due to their smaller size, the capture of single micro-beads requires greater confinement of the electrical field gradients (and corresponding DEP force). For this reason, 20 μm gaps in the patterned parylene were used for single cell capture and 10 μm gaps for single-bead capture. The particles were tested at a concentration of 10⁶/mL in a 100 μm wide microfluidic channel. This example shows that the use of a circularly shaped parylene pattern can increase the positioning accuracy of beads/cells as compared to an unoptimized rectangular geometry.

### Example 2

### Single Cell/Bead Manipulation

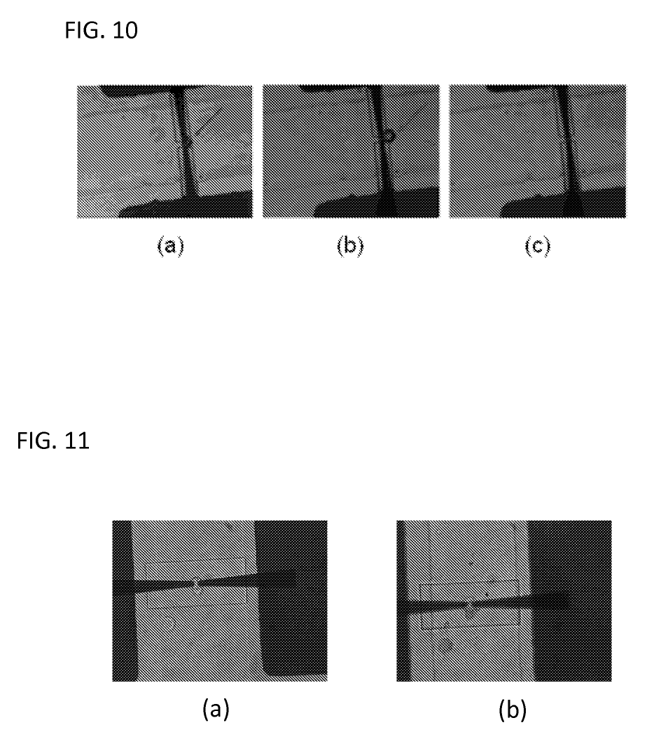

Although the above discussion has focused on the ability to capture single cells/beads using pDEP, the current invention also has the potential for unique opportunities to manipulate single cells/beads. Previous work has demonstrated bubble-release of microbeads through laser heating. (See, e.g., W. Tan and S. Takeuchi, PNAS, 2007, 104, 1146-1151, the disclosure of which is incorporated herein by reference.) In this example, a much simpler technology for bubble release, namely, the generation of bubbles via electrolysis is presented. For example, FIGS. 10a to 10c provide images showing bead capture and release using the pDEP capture device of the current invention. As shown, once a bead is captured (10a), a decrease of the applied frequency (down to a few Hz) either leads to the reversal of the electrical polarization, which would create a nDEP paradigm and repulse the bead, or, as shown here, bubble generation by electrolysis. As shown, the bubble pushes the bead back into the fluid flow (10b). When the frequency is raised back to 1 MHz, the bubble is eliminated and the device can be reused to capture other beads/cells (10c). In the current example, the test was done with 50 μm wide channel. When the frequency was lowered to a few Hz, a bubble began to form. A continuous flow of distilled water was maintained. As the bubble became larger, the beads were released into the flow of water. Raising the frequency back to 1 MHz eliminated the bubble, preparing the device for reuse.

### Example 3

### Cell Vitality with pDEP

It is important that the parameters used for dielectrophoretic capture be tuned such that the cell is not harmed. In this example, a Trypan Blue assay was used to assess cell vitality following pDEP cell capture. As shown in FIG. 11a, cells were not stained 15 minutes after capture. To confirm that the Trypan Blue assay was functioning, cells were allowed to sit in the microfluidic device, with no incubation. Cells were imaged again after 3 hours (FIG. 11b). At this point the cells were dead and stained blue under the Trypan Blue assay.

### CONCLUSION

In conclusion, the technology for single particle capture and release within a microfluidic environment was developed. It allows for robust control of the number and position of particles. This level of control has significant promise for single-cell analysis.

For example, the ability to not only capture but also manipulate individual beads allows for both more robust single particle capture (through the ability to correct errors if multiple beads are captured) and the potential for separate capture and detection chambers. This, in turn would allow for a single detector for an entire capture array, or for the controlled sequential transmission of single micro-beads through multiple processing chambers (easily performed in parallel for multiple beads; if the fluidic architecture is used to separate the individual beads then shared electrical connections can be used). In addition, the chip can be reused by controlling the capture and release of beads and cells.

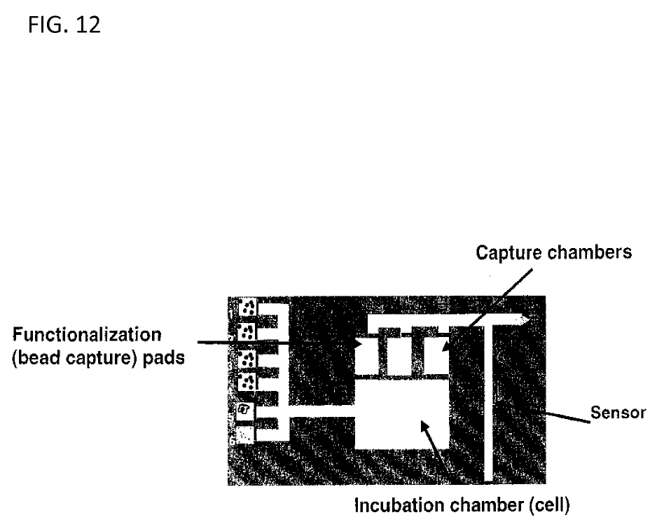

One such exemplary device is shown schematically in FIG. 12. As shown, using the instant pDEP capture device, target immobilization on functionalized beads or cells would take place in capture chambers where they would be immobilized by the pDEP capture device. Once captures, the beads/cells could then be released one at a time to flow to a separate sensor chamber. Such an architecture has a number of advantages, including:
For chips with integrated (on-chip imaging) it allows a higher density of beads in the capture chamber than can be achieved with current technology;
It maintains a pristine environment in the sensor chamber for optimal imaging/detection; and
It allows the same sensor to be used for multiple “detection chambers”, reducing the complexity and cost of the individual chips.

In short, the single cell pDEP capture and manipulation device of the current invention allows for the isolation and monitoring of an array of single cells or secreted proteins from such cells by any suitable technique, such as, for example, immunofluorescent assay, MEMS assay, etc. In addition, the capture of single cells would allow for controlled cell lysis and monitoring of non-secreted proteins measured by suitable techniques, such as, for example, immunofluorescent assay, MEMS assay, etc. Or, for example, the technique would allow for mRNA from captured cells to be prepared for either on-chip RT-PCR or transfer to an off-chip genome sequencer for transcriptome analysis.

### DOCTRINE OF EQUIVALENTS

Those skilled in the art will appreciate that the foregoing examples and descriptions of various preferred embodiments of the present invention are merely illustrative of the invention as a whole, and that variations of the present invention may be made within the spirit and scope of the invention. For example, it will be clear to one skilled in the art that alternative pDEP techniques or alternative configurations of the method and/or apparatus would not affect the improved pDEP capture and manipulation process of the current invention nor render the method unsuitable for its intended purpose. Accordingly, the present invention is not limited to the specific embodiments described herein but, rather, is defined by the scope of the appended claims.

What is claimed is:

1. A pDEP microfluidic single particle capture device comprising:
at least one pair of electrodes in fluid communication with at least one microfluidic channel, the at least one pair of electrodes having shielded and exposed regions, wherein the exposed regions define a particle capture region and are dimensioned and disposed in relation to each other such that an electric field is propagated thereby, the electric field having a frequency and being nonuniform across and localized on the size-scale of the particle, such that an attractive positive electrical polarization is generated between the particle and the exposed regions of the at least one pair electrodes sufficient to generate a restoring force at the particle capture region capable of fixing a single particle in place but that dissipates at a distance away from the particle capture region such that additional particles are not captured.

2. The pDEP microfluidic capture device set forth in claim 1, wherein the electrodes are shielded with a material having a low dielectric constant.

3. The pDEP microfluidic capture device set forth in claim 1, wherein the material is parylene.

4. The pDEP microfluidic capture device set forth in claim 1, wherein the electrodes have a geometry selected from the group consisting of semicircular and triangular.

5. The pDEP microfluidic capture device set forth in claim 1, wherein the particle is one of either a cell or a bead.

6. The pDEP microfluidic capture device set forth in claim 5, wherein the device is designed to operate in a fluid medium comprising a cell growth medium.

7. The pDEP microfluidic capture device set forth in claim 1, wherein the frequency of the electric field is at least 500 kHz.

8. The pDEP microfluidic capture device set forth in claim 1, wherein the frequency of the electric field may be reduced such that a repulsive force is generated at the particle capture region sufficient to dislodge a particle captured thereon.

9. The pDEP microfluidic capture device set forth in claim 8, wherein the repulsive force is created by the formation of gas bubbles through electrolysis.

10. The pDEP microfluidic capture device set forth in claim 1, wherein the microfluidic channel has a height of less than 12 μm.

11. The pDEP microfluidic capture device set forth in claim 1, wherein the at least one microfluidic channel is formed of PDMS.

12. A method of capturing single particles comprising:
providing at least one microfluidic channel having disposed therein at least one particle in a fluid medium;
positioning at least one pair of electrodes in fluid communication with the at least one microfluidic channel, the at least one pair of electrodes having shielded and exposed regions, wherein the exposed regions define a particle capture region;
propagating an electric field at the particle capture region having a frequency and being nonuniform across and localized on the size-scale of the particle, such that an attractive positive electrical polarization is generated between the particle and the exposed regions of the at least one pair electrodes sufficient to generate a restoring force at the particle capture region capable of fixing a single particle in place but that dissipates at a distance away from the particle capture region such that additional particles are not captured.

13. The method set forth in claim 12, wherein the electrodes are shielded with a material having a low dielectric constant.

14. The method set forth in claim 12, wherein the material is parylene.

15. The method set forth in claim 12, wherein the electrodes have a geometry selected from the group consisting of semicircular and triangular.

16. The method set forth in claim 12, wherein the particle is one of either a cell or a bead.

17. The method set forth in claim 16, wherein the fluid medium is a cell growth medium.

18. The method set forth in claim 12, wherein the frequency of the electric field is at least 500 kHz.

19. The method set forth in claim 12, reducing the frequency of the electric field such that a repulsive force is generated at the particle capture region sufficient to dislodge a particle captured thereon.

20. The method set forth in claim 19, wherein reducing the frequency of the electric field generates gas bubbles at the particle capture region through electrolysis.

21. The method set forth in claim 12, wherein the microfluidic channel has a height of less than 12 μm.

22. The method set forth in claim 12, wherein the at least one microfluidic channel is formed of PDMS.
